(19) United States
(12) Patent Application Publication
(10) Pub. No.: US 2025/0173986 A1
(43) Pub. Date: May 29, 2025

(54) MEASUREMENT SYSTEM AND STORAGE MEDIUM STORING MEASUREMENT PROGRAM

(71) Applicant: KABUSHIKI KAISHA TOSHIBA, Tokyo (JP)

(72) Inventors: Hiroaki NAKAMURA, Kawasaki (JP); Yu TAKEDA, Yokohama (JP); Takuma JINNAI, Yokohama (JP)

(73) Assignee: KABUSHIKI KAISHA TOSHIBA, Tokyo (JP)

(21) Appl. No.: 18/602,112

(22) Filed: Mar. 12, 2024

(30) Foreign Application Priority Data
Nov. 27, 2023 (JP) 2023-199719

(51) Int. Cl. G06T 19/20; G06T 7/50

(52) U.S. Cl. CPC G06T 19/20; G06T 7/50; G06T 2219/2004

(57) ABSTRACT

According to one embodiment, a measurement system includes a processor. The processor selects a data set from a database, based on similarity obtained from a result of comparison between an ideal image and a measurement image. The database stores a data set for measurement objects each including the ideal image, an alignment point cloud, and a shape comparison point cloud, when viewed from a plurality of fields of view. The processor aligns the alignment point cloud included in the selected data set with a measurement point cloud. The processor calculates a shape deviation between the shape comparison point cloud and the measurement point cloud, which are included in the selected data set, based on a result of the alignment. The processor visualizes on a display device based on a result of the calculation of the shape deviation.

### CROSS-REFERENCE TO RELATED APPLICATION

This application is based upon and claims the benefit of priority from prior Japanese Patent Application No. 2023-199719, filed Nov. 27, 2023, the entire contents of which are incorporated herein by reference.

### FIELD

Embodiments described herein relate generally to a measurement system and a storage medium storing a measurement program.

### BACKGROUND

As one of the technologies to support the manufacturing of large structures, there is a known technology to superimpose a three-dimensional image of components with an ideal shape on a three-dimensional image of components based on three-dimensional measurements of components of a large structure during manufacturing and thus visualize a deviation of the shape of components of the large structure during manufacturing from the ideal shape.

The visualization technology requires that the measured point cloud could accurately be aligned with an ideal point cloud. In order to align them accurately in a short time, it is desirable to obtain a measurement point cloud similar to the ideal point cloud, but it is generally difficult to prepare a measurement point cloud similar to the ideal point cloud.

### BRIEF DESCRIPTION OF THE DRAWINGS

FIG. 1 is a block diagram showing a configuration of an example of a measurement system according to a first embodiment.

FIG. 2 is a diagram showing an example of a hardware configuration of the measurement system according to the first embodiment.

FIG. 3 is a flowchart showing a shape deviation visualization process as an operation of the measurement system according to the first embodiment.

FIG. 4 is a conceptual diagram of comparison of depth images.

FIG. 5 is a conceptual diagram of alignment.

FIG. 6 is a conceptual diagram of the calculation of the shape deviation.

FIG. 7 is a block diagram showing a configuration of an example of a measurement system according to a modification of the first embodiment.

FIG. 8 is a flowchart showing a shape deviation visualization process as an operation of the measurement system according to the modification of the first embodiment.

FIG. 9 is a conceptual diagram of comparison of point clouds.

FIG. 10 is a conceptual diagram of a data set stored in the shape database of the second embodiment.

FIG. 11 is a flowchart showing an operation of the measurement system according to the second embodiment.

FIG. 12 is a diagram showing an example of display of a guide.

FIG. 13 is a flowchart showing an operation of a measurement system according to a third embodiment.

### DETAILED DESCRIPTION

In general, according to one embodiment, measurement system includes a processor with hardware. The processor selects a data set from a database, based on similarity obtained from a result of comparison between an ideal image and a measurement image. The ideal image is an image of an ideal measurement object having an ideal shape for a measurement object. The measurement image is an image of the measurement object obtained by measuring the measurement object. The database stores a data set for measurement objects each including the ideal image, an alignment point cloud, and a shape comparison point cloud, when viewed from a plurality of fields of view. The alignment point cloud is used for alignment with the measurement point cloud. The shape comparison point cloud is used for comparison of shape with the measurement point cloud. The processor aligns the alignment point cloud included in the selected data set with the measurement point cloud. The processor calculates a shape deviation between the shape comparison point cloud and the measurement point cloud, which are included in the selected data set, based on a result of the alignment. The processor visualizes on a display device based on a result of the calculation of the shape deviation.

Embodiments will now be described with reference to the drawings.

### First Embodiment

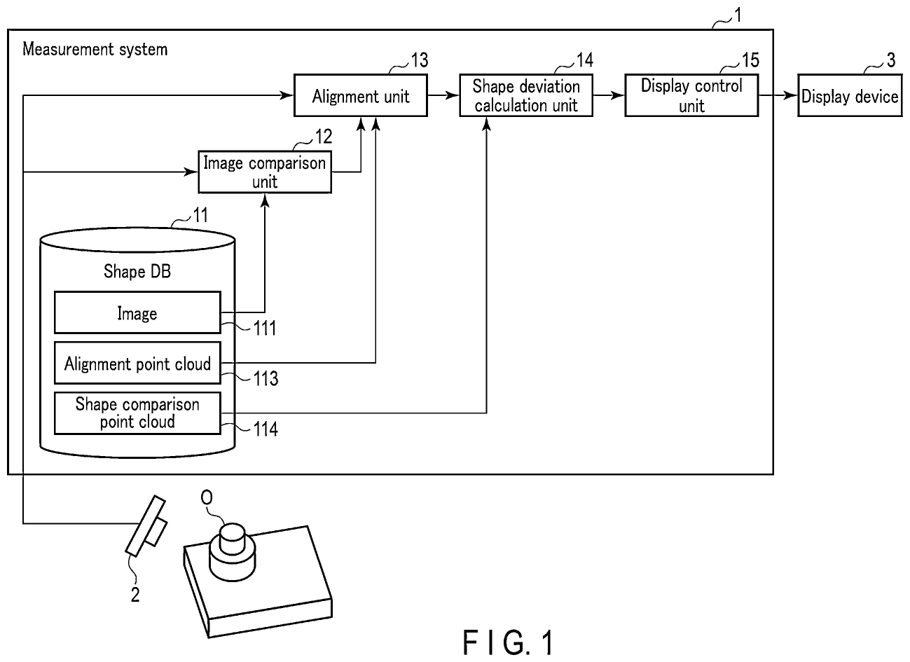

First is a description of a first embodiment. FIG. 1 is a block diagram showing a configuration of an example of a measurement system according to the first embodiment. The measurement system 1 can be used to measure a three-dimensional shape of a measurement object.

In the first embodiment, the measurement system 1 compares a three-dimensional shape of a measurement object O measured by a camera 2 and a three-dimensional shape of an ideal measurement object with an ideal three-dimensional shape for the measurement object O, and presents a user with a shape deviation between the three-dimensional shapes. The measurement object O is, for example, a component welded to a large structure, though it is not limited thereto. The measurement object need not be of one type but may be of a plurality of types. As shown in FIG. 1, the measurement system 1 includes a shape database (DB) 11, an image comparison unit 12, an alignment unit 13, a shape deviation calculation unit 14 and a display control unit 15. The measurement system 1 is configured to perform communications with the camera 2. The communications may be performed wirelessly or by wire. The measurement system 1 is also configured to perform communications with the display device 3. The communications may also be performed wirelessly or by wire.

The camera 2 is configured to measure information regarding a point cloud of the measurement object O. The camera 2 is an RGB-D camera, for example. The RGB-D camera is configured to measure RGB-D images. The RGB-D images include a depth image and a color image (RGB color image). The depth image is a two-dimensional image having the depth of each point of the measurement object O as a pixel value. The color image is a two-dimensional image having RGB values of each point of the measurement object O as pixel values.

The display device 3 is a liquid crystal display, an organic EL display, and the like. The display device 3 displays a variety of images based on data transferred from the measurement system 1.

The shape DB 11 is a database that stores a data set about an ideal measurement object having an ideal three-dimensional shape for each measurement object. The data set includes an image 111, an alignment point cloud 113 and a shape comparison point cloud 114. The image 111 includes a plurality of images corresponding to an ideal measurement object viewed from a plurality of fields of view. Similarly, the alignment point cloud 113 and the shape comparison point cloud 114 each include a plurality of point clouds corresponding to an ideal measurement object viewed from a plurality of fields of view. The image 111, alignment point cloud 113 and shape comparison point cloud 114, which correspond to the same ideal measurement object viewed from the same field of view, constitute one data set.

The image 111 is an image of each ideal measurement object. The image 111 includes one or both of a depth image and a color image of the ideal measurement object. Hereinafter, the depth image of the ideal measurement object may be referred to as an ideal depth image, and the color image of the ideal measurement object may be referred to as an ideal color image.

The alignment point cloud 113 is a point cloud of an ideal measurement object for alignment with the point cloud of a measurement object O obtained from the depth image measured by the camera 2. The alignment point cloud 113 is a point cloud obtained by excluding, from the shape comparison point cloud 114, a point cloud corresponding to a shape comparison portion compared with the measurement object O.

The shape comparison portion is a portion where a shape deviation may occur between the point cloud of the measurement object O and that of the ideal measurement object. For example, in a component welded to a large structure, an excess metal may be generated by the welding. The excess metal is a portion to which metal is welded more than the dimension of welded metal that is defined as an ideal shape. The portion where such an excess metal may be generated corresponds to the shape comparison portion. The difference in the shape of the shape comparison portion between the point cloud of the measurement object O and that of the ideal measurement object can be an error factor in the alignment of point clouds for the comparison of shape deviations. To eliminate the error factor, the alignment is performed using the alignment point cloud 113 from which the shape comparison portion is excluded in advance. The alignment of point clouds can be performed more accurately even among point clouds having a sparser density than the comparison of shape deviations. Thus, the alignment point cloud 113 may be a point cloud obtained by down-sampling the shape comparison point cloud 114 and then excluding a point cloud corresponding to the shape comparison portion from the down-sampled point cloud.

The shape comparison point cloud 114 is a point cloud of an ideal measurement object for comparison of shape deviation with the point cloud of the measurement object O obtained from the depth image measured by the camera 2. The shape comparison point cloud 114 is preferably a point cloud having the same density as the point cloud of the measurement object O. As described above, the shape comparison point cloud 114 also includes a point cloud corresponding to a shape comparison portion.

The image 111, alignment point cloud 113 and shape comparison point cloud 114 can be generated, for example, from 3D computer aided design (CAD) data of the ideal measurement object. As an example, the image 111 and shape comparison point cloud 114 are obtained by placing a virtual RGB-D camera in a predetermined position relative to a 3D CAD model of the ideal measurement object, changing the position of the virtual RGB-D camera by a constant width in the horizontal and vertical directions relative to the predetermined position, and generating from the 3D CAD data images and point clouds to be acquired by the virtual RGB-D camera. The alignment point cloud 113 is also obtained by excluding a shape comparison portion from the shape comparison point cloud 114. If position information indicating a shape comparison portion such as a welding portion is included in the 3D CAD data, the shape comparison portion is specified based on the position information. Alternatively, the shape comparison portion may be specified by an operator who produces a data set.

The image 111, alignment point cloud 113 and shape comparison point cloud 114 may be obtained by taking an image of the actual ideal measurement object using the RGB-D camera.

The shape DB 11 may be provided outside the measurement system 1. In this case, the measurement system 1 acquires information from the shape DB 11 as necessary.

The image comparison unit 12 compares a measurement image that is an image of a measurement object O obtained by the camera 2 with the image 111 stored in the shape DB 11 to detect similarity therebetween, and selects a data set based on the similarity. The similarity may be a result of correlation operation between images, for example. The image comparison unit 12 may detect the similarity with one or both of the depth image and the color image. In addition, the image comparison unit 12 can generate color histograms of the measurement and color images and compare the color histograms to identify colors having no similarity.

The alignment unit 13 aligns the alignment point cloud 113 included in the data set selected by the image comparison unit 12 and the measurement point cloud that is a point cloud of the measurement object O obtained by the camera 2. The alignment unit 13 aligns the point clouds using a matching technique such as an iterative closest point (ICP) technique and a coherent point drift (CPD) technique. In addition, if the image comparison unit 12 specifies a color having no similarity, the alignment unit 13 can filter the point cloud of the color from the measurement point cloud to align the point clouds.

The shape deviation calculation unit 14 calculates a shape deviation between a measurement point cloud and a shape comparison point cloud 114 included in the data set selected by the image comparison unit 12. The shape deviation calculation unit 14 calculates a shape deviation from the difference between each point of the measurement point cloud aligned based on the alignment result by the alignment unit 13 and each point of the shape comparison point cloud 142. The shape deviation may be, for example, a difference in value at the same position between the shape comparison point cloud 114 and the measurement point cloud.

The display control unit 15 visualizes the comparison result obtained by the shape deviation calculation unit 14 on the display device 3. The visualization is performed, for example, by superimposing a three-dimensional image, which is based upon the shape comparison point cloud 114, on a three-dimensional image that is based upon the measurement point cloud and highlighting a portion having a large shape deviation between the measurement point cloud and the shape comparison point cloud 114. The highlighting may be performed by an optional technique, such as changing the density of color displayed in accordance with the shape deviation. In addition, the display control unit 15 may display a guide, which will be described later.

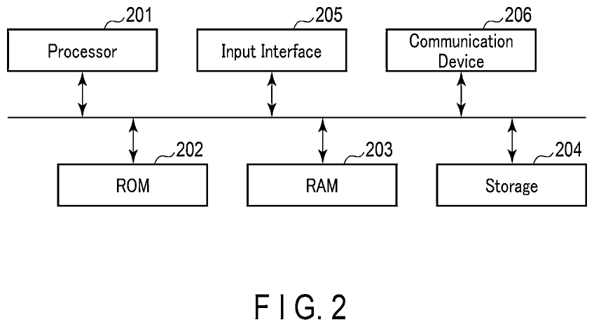

FIG. 2 is a diagram showing an example of a hardware configuration of the measurement system 1. The measurement system 1 may be a variety of terminal devices such as a personal computer (PC) and a tablet terminal. As shown in FIG. 2, the measurement system 1 includes as hardware a processor 201, a read only memory (ROM) 202, a random access memory (RAM) 203, a storage 204, an input interface 205 and a communication device 206.

The processor 201 controls the overall operation of the measurement system 1. The processor 201 executes a measurement program stored in the storage 204, for example to operate as the image comparison unit 12, alignment unit 13, shape deviation calculation unit 14 and display control unit 15. The processor 201 is, for example, a central processing unit (CPU). The processor 101 may be a micro-processing unit (MPU), a graphics processing unit (GPU), an application specific integrated circuit (ASIC), a field programmable gate array (FPGA) or the like. The processor 201 may be a single CPU, a plurality of CPUs or the like.

The ROM 202 is a nonvolatile memory. The ROM 202 stores, for example, a start program of the measurement system 1. The RAM 203 is a volatile memory. The RAM 203 is used as a work memory in processing in the processor 201, for example.

The storage 204 is, for example, a hard disk drive or a solid-state drive. The storage 204 stores various programs to be executed by the processor 201, such as measurement programs. The storage 204 may also store the shape DB 11. The shape DB 11 need not necessarily be stored in the storage 204.

The input interface 205 includes an input device such as a touch panel, a keyboard and a mouse. If the input device of the input interface 205 is operated, a signal corresponding to the operation is input to the processor 201. The processor 201 performs various processes in response to the signal.

The communication device 206 is a communication device through which the measurement system 1 communicates with an external device such as the camera 2 and display device 3. The communication device 206 may be a communication device for wired communication or a communication device for wireless communication.

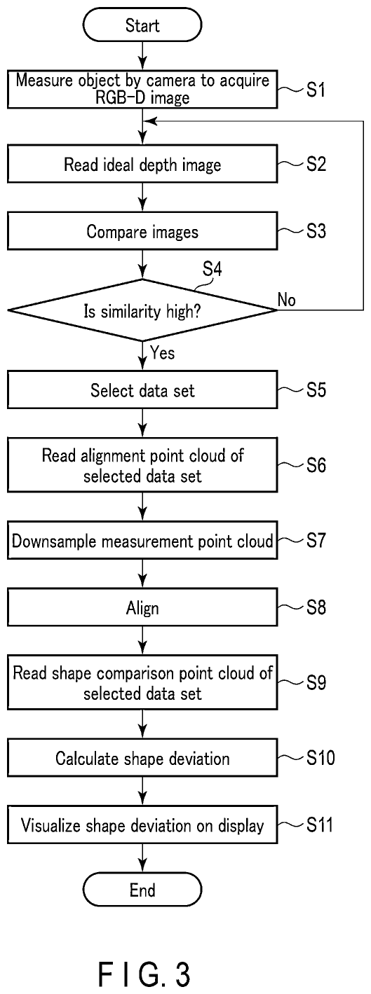

Next is a description of an operation of the measurement system 1 according to the first embodiment. FIG. 3 is a flowchart showing a shape deviation visualization process as an operation of the measurement system 1 according to the first embodiment. The shape deviation visualization process shown in FIG. 3 is performed by the processor 201.

In step S1, the processor 201 controls the camera 2 to measure a measurement object O. Then, the processor 201 acquires an RGB-D image from the camera 2. The measurement object O may be performed by the user. In this case, the user holds the camera 2 in his or her hands to measure the measurement object O.

In step S2, the processor 201 reads one ideal depth image from the shape DB 11. For example, the processor 201 reads ideal depth images in the numerical order assigned to a data set. In step S2, the processor 201 may read ideal color images instead of the ideal depth images.

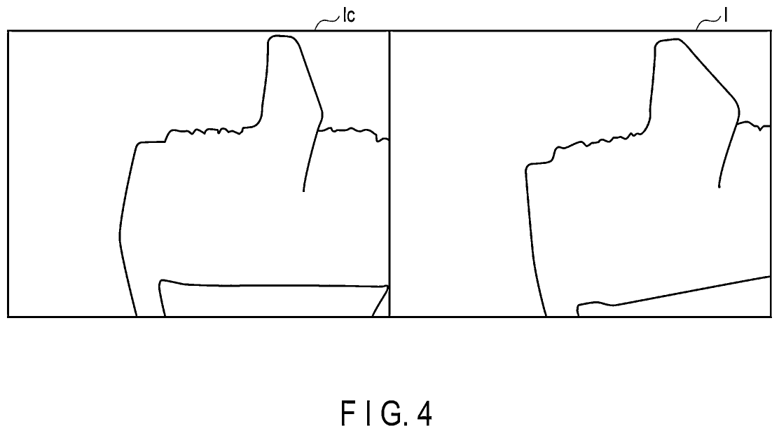

In step S3, the processor 201 compares the read ideal depth image and the measured depth image that is the depth image of the measurement object O to calculate similarity between them. FIG. 4 is a conceptual diagram of comparison of depth images. The similarity may be calculated, for example, as a correlation value between the ideal depth image Ic and measured depth image I shown in FIG. 4. The correlation value is the sum of differences in depth values between pixels corresponding to the ideal depth image Ic and the measured depth image I. The correlation value thus calculated indicates that as it decreases, the similarity between the two images increases. The similarity may be calculated by various techniques other than correlating operation. In step S3, the processor 201 may compare the images by color.

In step S4, the processor 201 determines whether the similarity is high. If the calculated similarity is the highest, the processor 201 determines that the similarity is high. If the calculated similarity is equal to or greater than a threshold value, the processor 201 also determines that the similarity is high. If the processor 201 determines in step S4 that the similarity is high, the process proceeds to step S5. If the processor 201 does not determine in step S4 that the similarity is high, the process returns to step S2. In this case, the processor 201 reads another ideal depth image from the shape DB 11 and compares the images again.

In step S5, the processor 201 selects a data set including the ideal depth image, which is determined to have high similarity, as a data set corresponding to the measurement object o.

In step S6, the processor 201 reads an alignment point cloud of the selected data set from the shape DB 11.

In step S7, the processor 201 generates a measurement point cloud from the depth image obtained from the camera 2 and downsamples the measurement point cloud to the same density as the read alignment point cloud. The downsampling method may be performed by any method such as averaging adjacent points.

In step S8, the processor 201 aligns the measurement point cloud and the alignment point cloud.

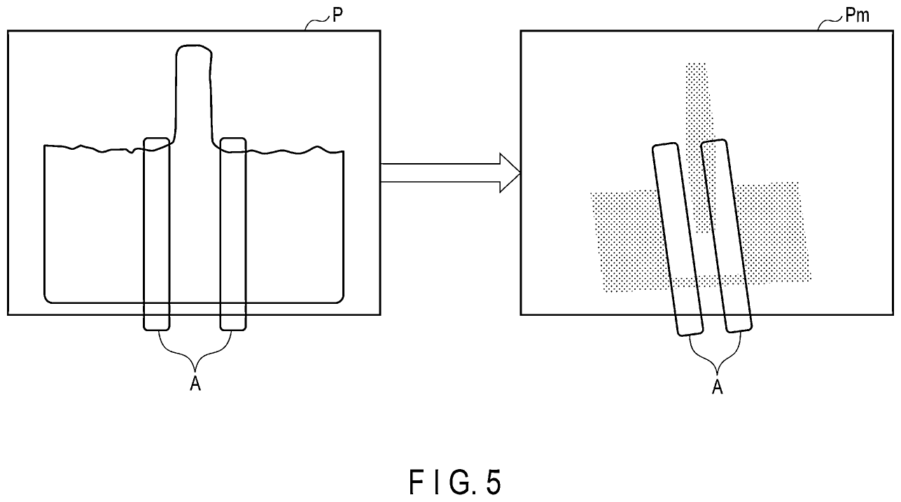

FIG. 5 is a conceptual diagram of the alignment. The alignment is performed such that the position of the measurement point cloud P shown in FIG. 5 is aligned with that of an alignment point cloud Pm. If the measurement object O is a component to be welded to a large structure, the measurement point cloud P may include a welding portion A to be welded to the large structure. As described above, the shape of the welding portion A is not constant but may vary depending on an excess metal or the like. The variation of the shape due to an excess metal or the like can be an error factor in the alignment. Therefore, a portion corresponding to the portion A as a shape comparison portion is removed from the alignment point cloud Pm. Even if the portion A is removed, a corner portion or the like which can be a reference for the alignment is left, with the result that the alignment can be performed with accuracy. The alignment may be performed by any technique such as an ICP technique.

In step S9, the processor 201 reads a shape comparison point cloud of the selected data set from the shape DB 11.

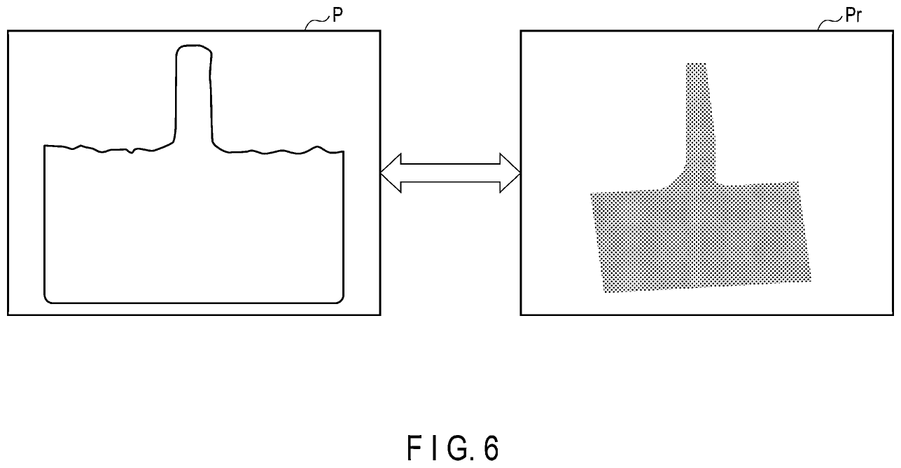

In step S10, the processor 201 calculates a shape deviation between the measurement point cloud and the shape comparison point cloud. FIG. 6 is a conceptual diagram of the calculation of the shape deviation. The calculation of the shape deviation is performed by calculating a deviation between corresponding points of the measurement point cloud P and the shape comparison point cloud Pr. In the calculation of the shape deviation, the measurement point cloud P is a point cloud that is not downsampled. The shape comparison point cloud Pr is a point cloud including a portion where a shape deviation may occur between the shape comparison point cloud Pr and the measurement point cloud P of the foregoing welding portion. The processor 201 aligns the measurement point cloud P and the shape comparison point cloud Pr on the basis of a result of the alignment to calculate the deviation between the corresponding points.

In step S11, the processor 201 visualizes the shape deviation on the display device 3 based on the result of the calculation. For example, the processor 201 superimposes a three-dimensional image, which is based upon the shape comparison point cloud, on a three-dimensional image that is based upon the measurement point cloud and displays the shape deviation by, for example, changing the density of color to be displayed according to the size of the shape deviation in the superimposed images. After that, the process of FIG. 3 ends.

As described above, according to the first embodiment, the shape DB stores a data set for an ideal measurement object having an ideal three-dimensional shape for each measurement object. The data set includes an image, an alignment point cloud and a shape comparison point cloud. The image includes a plurality of images corresponding to the ideal measurement object viewed from a plurality of fields of view. The alignment point cloud and the shape comparison point cloud include a plurality of point clouds corresponding to the ideal measuring object viewed from a plurality of visual fields. By selecting a data set by comparing the image obtained by the camera with the image included in the data set, an alignment point cloud and a shape comparison point cloud, which correspond to the ideal measurement object viewed from a field of view close to the measurement point cloud based on the measurement result obtained by the camera 2, can be selected. It is thus expected that the point cloud alignment and shape comparison can easily be performed with high accuracy. Since the comparison of image similarities is generally performed at a lower load than that of point cloud similarities, it is expected that the comparison of similarities for selecting a data set is also performed at a lower load.

In addition, the alignment point cloud is a point cloud in which a shape comparison portion is removed from the shape comparison point cloud. The removal of a shape comparison portion enables high-accuracy alignment. The alignment point cloud is also a point cloud whose density is lower than that of the shape comparison point cloud. The point cloud alignment requires only a point as a reference for alignment and does not require a high-density point cloud such as the shape comparison point cloud. Therefore, the capacity of the shape DB can be prevented from increasing by making the density of the alignment point cloud lower than that of the shape comparison point cloud.

### Modification of First Embodiment

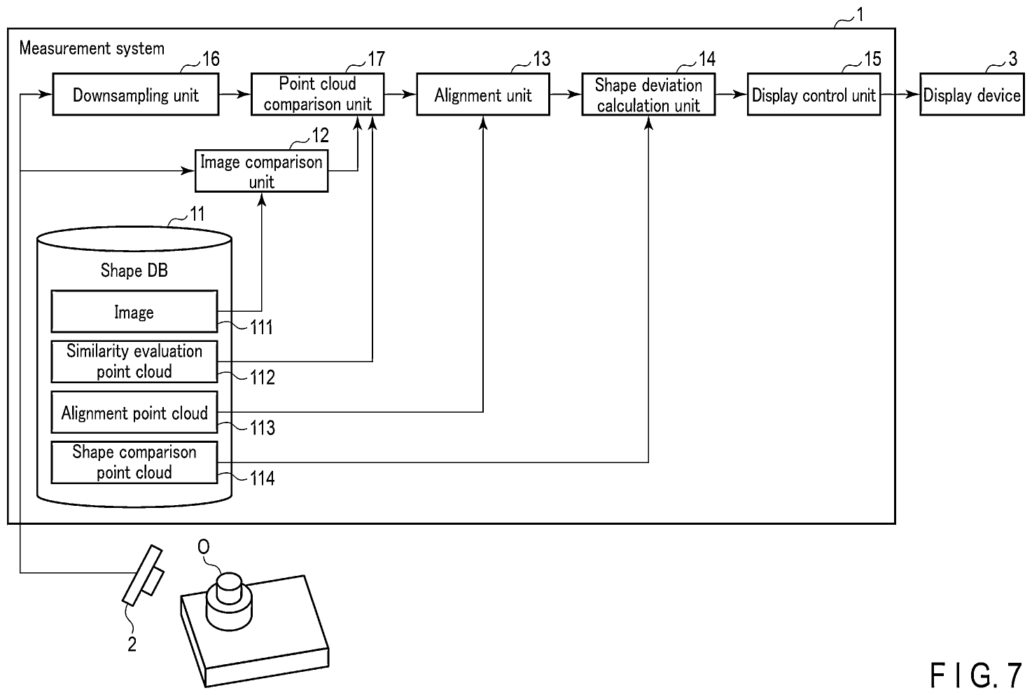

Next is a description of a modification of the first embodiment. FIG. 7 is a block diagram showing a configuration of an example of a measurement system according to the modification of the first embodiment. In the following modification, the descriptions overlapping with those of the first embodiment may be omitted.

As shown in FIG. 7, the measurement system 1 of the modification of the first embodiment includes a shape database (DB) 11, an image comparison unit 12, an alignment unit 13, a shape deviation calculation unit 14, a display control unit 15, a downsampling unit 16 and a point cloud comparison unit 17.

Similar to the shape DB 11 of the first embodiment, the shape DB 11 of the modification is a database that stores a data set of ideal measurement objects for each measurement object. The data set includes an image 111, a similarity evaluation point cloud 112, an alignment point cloud 113 and a shape comparison point cloud 114. The image 111, alignment point cloud 113 and shape comparison point cloud 114 are the same as those described in the first embodiment. Similar to the alignment point cloud 113 and shape comparison point cloud 114, the similarity evaluation point cloud 112 includes a plurality of point clouds corresponding to the ideal measurement object viewed from a plurality of fields of view.

The similarity evaluation point cloud 112 is an ideal measurement object point cloud for evaluating the similarity of the measurement object O obtained from the depth image measured by the camera 2 with the point cloud. The similarity evaluation point cloud 112 is a point cloud obtained by downsampling the shape comparison point cloud 114.

The downsampling unit 16 downsamples the measurement point cloud to the same density as that of the similarity evaluation point cloud 112. The downsampling method may be performed by any technique, such as averaging adjacent points.

The image comparison unit 12 of the modification compares similarity between a measurement image that is an image of the measurement object O obtained by the camera 2 and the image 111 stored in the shape DB 11, and selects a data set of a predetermined field of view based on the comparison result of the similarity. The predetermined field of view is, for example, a field of view for several sets of surroundings including a position of the image 111 whose similarity is determined to be high.

The point cloud comparison unit 17 compares similarity between the similarity evaluation point cloud 112 included in the data set of the predetermined field of view selected by the image comparison unit 12 and the measurement point cloud downsampled by the downsampling unit 16, and selects a data set based on the comparison result of the similarity. The similarity may be, for example, a result of correlating operation between the point clouds.

The alignment unit 13 performs alignment between the alignment point cloud 113 included in the data set selected by the point cloud comparison unit 17 and the measurement point cloud that is a point cloud of the measurement object O obtained by the camera 2.

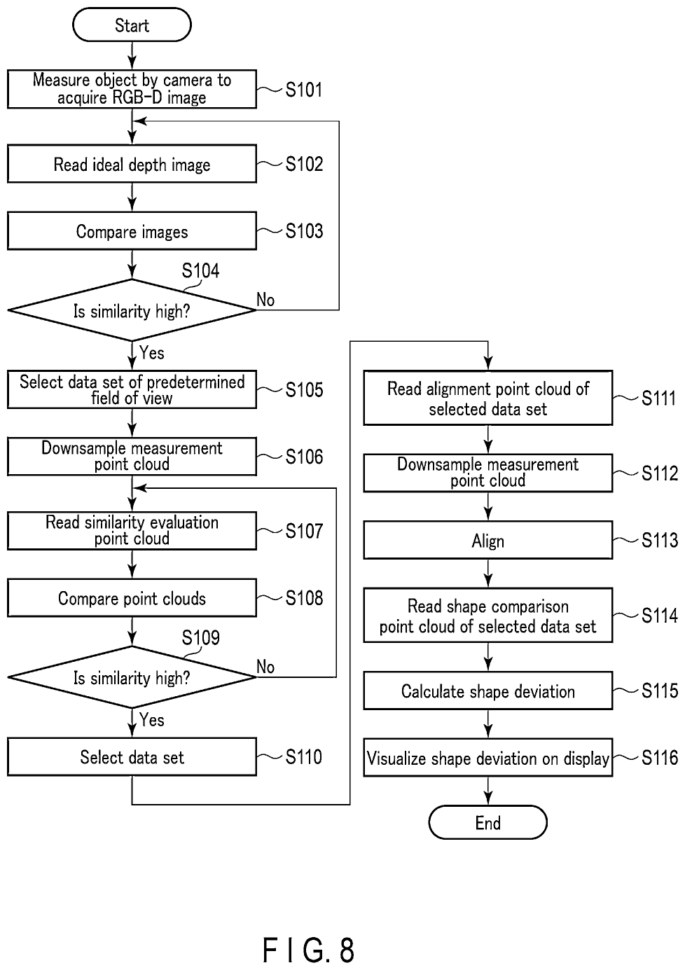

Next is a description of the operation of the measurement system 1 according to the modification of the first embodiment. FIG. 8 is a flowchart showing a shape deviation visualization process as an operation of the measurement system 1 according to the modification of the first embodiment. The process of FIG. 8 is performed by the processor 201.

In step S101, the processor 201 controls the camera 2 to measure a measurement object O. Then, the processor 201 acquires an RGB-D image from the camera 2. The measurement object O may be measured by the user. In this case, the user holds the camera 2 in his or her hand to measure the measurement object O.

In step S102, the processor 201 reads one ideal depth image from the shape DB 11. The processor 201 reads ideal depth images, for example, in the numerical order assigned to the data set. In step S102, the processor 201 may read ideal color images instead of the ideal depth images.

In step S103, the processor 201 compares the read ideal depth image and the measured depth image that is the depth image of the measurement object O to calculate similarity between them. In step S103, the processor 201 may compare the color images.

In step S104, the processor 201 determines whether the similarity is high. If the calculated similarity is the highest, the processor 201 determines that the similarity is high. If the calculated similarity is equal to or greater than a threshold value, the processor 201 also determines that the similarity is high. If the processor 201 determines in step S104 that the similarity is high, the process proceeds to step S105. If the processor 201 does not determine in step S104 that the similarity is high, the process returns to step S102. In this case, the processor 201 reads another ideal depth image from the shape DB 11 and compares the images again.

In step S105, the processor 201 selects, as a data set corresponding to the measurement object O, a data set in a predetermined field of view relative to the data set including the ideal depth image whose similarity is determined to be high. The predetermined field of view is, for example, a field of view for several sets for surroundings of the position of the ideal depth image whose similarity is determined to be high. If the predetermined field of view is wide, the accuracy of point cloud comparison is increased, as is the load of processing required for point cloud comparison. If the predetermined field of view is narrow, the accuracy of point cloud comparison is decreased, as is the load of processing required for point cloud comparison.

In step S106, the processor 201 generates a measurement point cloud from the depth image obtained from the camera 2 to downsample the measurement point cloud to the same density as that of the read similarity evaluation point cloud. The downsampling method may be performed by any technique, such as averaging adjacent points.

In step S107, the processor 201 reads one similarity evaluation point cloud of the selected data set from the shape DB 11. The processor 201 reads the similarity evaluation point cloud in the numerical order assigned to the data set, for example.

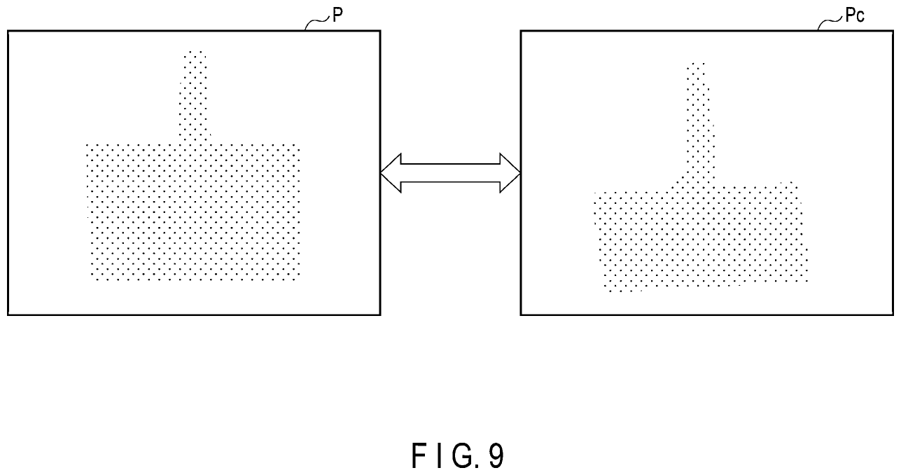

In step S108, the processor 201 compares the downsampled measurement point cloud and the read similarity evaluation point cloud to calculate similarity between them. FIG. 9 is a conceptual diagram of comparison of point clouds. The similarity can be calculated as a correlation value between a similarity evaluation point cloud Pc and a measurement point cloud P which are shown in FIG. 9, for example. The correlation value is the sum of differences between corresponding points of the similarity evaluation point cloud Pc and measurement point cloud P. The correlation value thus calculated indicates that as it decreases, the similarity between the two images increases. The similarity may be calculated by various techniques other than correlating operation.

In step S109, the processor 201 determines whether the similarity is high. If the calculated similarity is the highest, the processor 201 determines that the similarity is high. If the calculated similarity is equal to or greater than a threshold value, the processor 201 also determines that the similarity is high. If the processor 201 determines in step S109 that the similarity is high, the process proceeds to step S110. If the processor 201 does not determine in step S109 that the similarity is high, the process returns to step S107. In this case, the processor 201 reads another shape evaluation point cloud from the data set selected from the shape DB 11 and compares the point clouds again.

In step S110, the processor 201 selects a data set including a shape evaluation point cloud whose similarity is determined to be high, as a data set corresponding to the measurement object O. The process of steps S111 to S116 is the same as that of steps S6 to S11 shown in FIG. 3. Thus, the description of the process is omitted.

As described above, according to the modification of the first embodiment, the data set includes a similarity evaluation point cloud in addition to an image, an alignment point cloud, a shape comparison point cloud. The point cloud comparison is performed to calculate similarity using a similarity evaluation point cloud of a data set of a predetermined field of view selected based on the result of comparison of images. It is thus expected to select an alignment point cloud and a shape comparison point cloud corresponding to an ideal measurement object viewed from a field of view that is closer to the measurement point cloud based on the measurement result obtained by the camera 2 than that in the first embodiment.

### Second Embodiment

Next is a description of a second embodiment. In the first embodiment and its modification described above, a data set is prepared for each measurement object. In work of attaching components to a large structure, predetermined components are often attached to the structure in a predetermined order. Considering the visualization of a shape deviation during the work, image comparison or point cloud comparison need not be performed using a data set of a measurement object that is not related to the work.

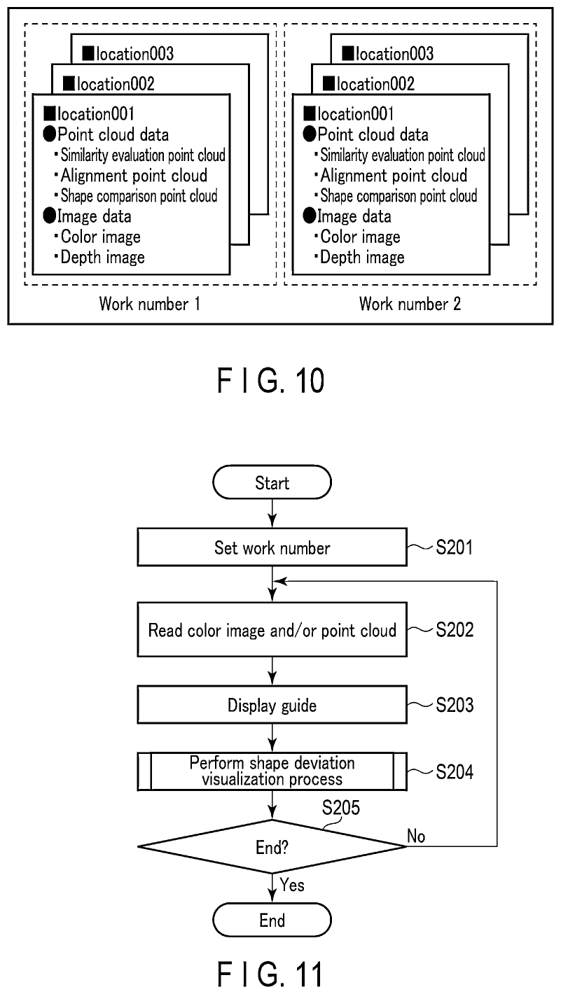

In the second embodiment, a data set is prepared for each work. FIG. 10 is a conceptual diagram of a data set stored in a shape DB 11 in the second embodiment. As shown in FIG. 10, the data set is prepared for each of work numbers 1, 2 and so on. The work numbers are unique numbers assigned to their respective works. The works are a series of component attachment, components machining, etc., and are not limited to a specific work.

The data set of each work number is further divided into data sets corresponding to their respective location numbers. Each of the location numbers is a unique number representing the location of a component to be attached as a measurement object in the work of the corresponding work number. Instead of the location number, for example, a number representing the order of work step may be used.

As described in the first embodiment and its modification, the data set of each location number includes an image, a similarity evaluation point cloud, an alignment point cloud and a shape comparison point cloud. The data set of each location number may not include a similarity evaluation point cloud. As described in the first embodiment and its modification, the image, similarity evaluation point cloud, alignment point cloud and shape comparison point cloud, which are included in the data set of each location number, include a plurality of images and a plurality of point clouds corresponding to the ideal measurement object viewed from a plurality of fields of view.

The configuration of the measurement system in the second embodiment is similar to those of the first embodiment and its modification, except that the data set stored in the shape DB 11 is prepared for each work. Detailed description of the second embodiment is therefore omitted.

Next is a description of the operation of the measurement system 1 according to the second embodiment. FIG. 11 is a flowchart showing the operation of the measurement system 1 according to the second embodiment. The process of FIG. 11 is performed by the processor 201.

In step S201, the processor 201 sets a work number. The work number is set in response to input from a user, for example. The user selects a work number of work to be performed from a work list displayed on the display device 3, for example. Accordingly, the processor 201 sets the work number.

In step S202, the processor 201 reads a point cloud generated from an ideal color image and/or an ideal depth image of one location number in a data set of the set work number. The processor 201 may read an ideal color image and/or a point cloud in order of location number, for example.

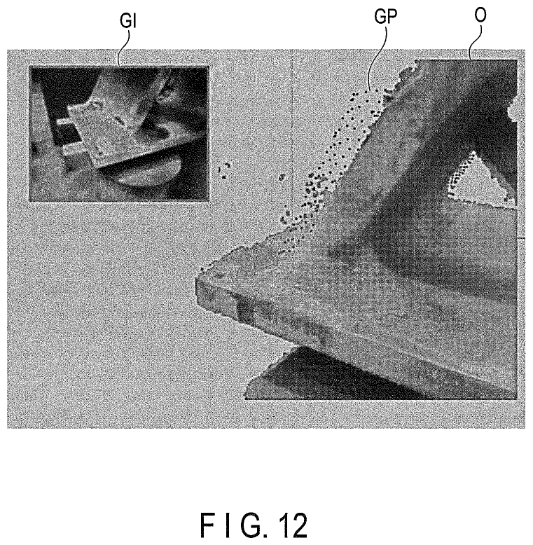

In step S203, the processor 201 displays a guide. FIG. 12 is a diagram showing an example of the display of a guide. In the display of a guide, the processor 201 displays the image of a measurement object O obtained by the camera 2 on the display device 3 and superimposes the read ideal color image as a guide image GI, for example, on the upper left corner of the image of the measurement object O. The processor 201 also superimposes a point cloud generated from the read ideal depth image as a guide point cloud GP on the measurement object O, for example.

In step S204, the processor 201 performs a shape deviation visualization process. The shape deviation visualization process is the operation of FIG. 3 in the first embodiment or the operation of FIG. 8 in the modification of the first embodiment. If RGB-D measurement of a measurement object O is performed by the user who holds the camera 2, the user can adjust the position of the camera 2 while looking at the guide image GI and/or the guide point cloud GP. Thus, the measurement object O whose position is similar to that of the measurement object O indicated by the guide image GI and/or the guide point cloud GP can be measured, with the result that image comparison and/or point cloud comparison can be performed easily and accurately. After the shape deviation visualization process, the process proceeds to step S205. The shift of the process from step S204 to step S205 may be performed in response to an instruction from the user.

In step S205, the processor 201 determines whether the work has been completed. For example, if the shape deviation visualization process is performed for all location numbers of the set work number, the processor 201 determine that the work has been completed. If the processor 201 determines in step S205 that the work has been completed, the process shown in FIG. 11 ends. If the processor 201 does not determine in step S205 that the work has been completed, the process returns to step S202. In this case, the processor 201 reads a point cloud generated from the ideal color image and/or ideal depth image of the next location number and performs a guide display process and a shape deviation visualization process for the next location number.

As described above, in the second embodiment, a data set is prepared for each work. Then, a shape deviation visualization process is performed for a set work. That is, in the second embodiment, neither image comparison nor point cloud comparison is performed using a data set of a measurement object that is not related to work. Thus, an alignment point cloud and a shape comparison point cloud, which correspond to a measurement object viewed from a field of view close to a measurement point cloud based on the measurement result obtained by the camera 2, can be selected in a shorter time than in the first embodiment.

Also, in the second embodiment, during RGB-D measurement, a user can adjust the position of the camera 2 while viewing the guide image GI and/or the guide point cloud GP. Thus, an alignment point cloud and a shape comparison point cloud, which correspond to an ideal measurement object viewed from a field of view close to a measurement point cloud based on the measurement result obtained by the camera 2, can be selected in a shorter time than in the first embodiment. Furthermore, in the second embodiment, the orientation of the camera 2 is guided by the guide image GI and/or the guide point cloud GP; thus, a field of view of an image, a similarity evaluation point cloud, an alignment point cloud and a shape comparison point cloud which need to be prepared for one measurement object, can be made narrower than that in the first embodiment and its modification. Therefore, the capacity of a data set for one measurement object may be reduced.

### Third Embodiment

Next is a description of a third embodiment. The configuration of a measurement system according to the third embodiment is basically the same as that of the measurement system of each of the first embodiment and its modification. In the third embodiment, however, the image 111 includes at least an ideal color image. The image 111 may or may not include an ideal depth image.

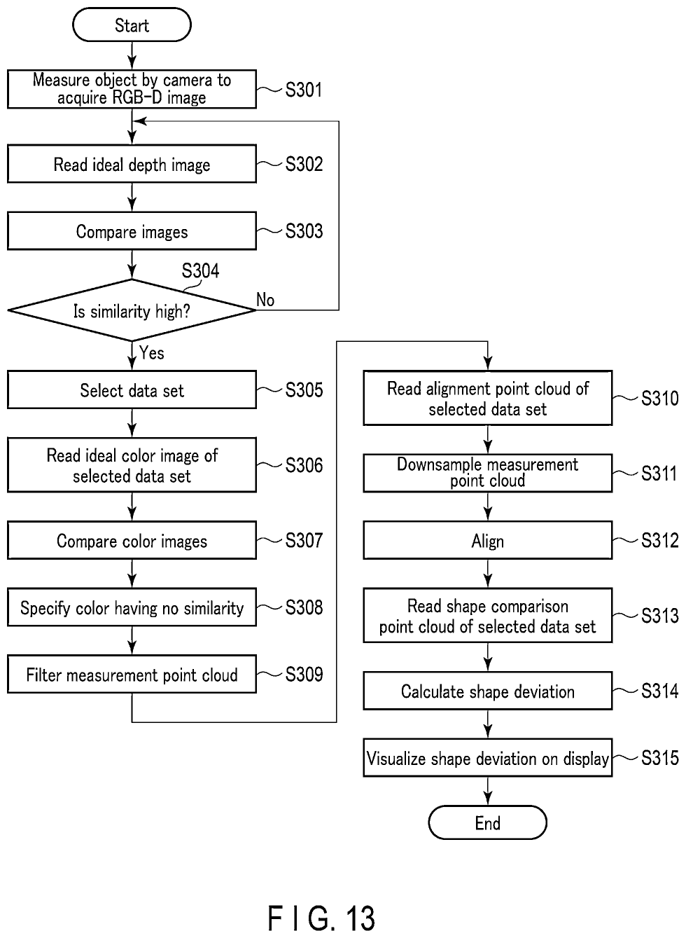

FIG. 13 is a flowchart showing an operation of the measurement system 1 of the third embodiment. The process shown in FIG. 13 is performed by the processor 201.

In step S301, the processor 201 controls the camera 2 to measure a measurement object O. Then, the processor 201 acquires an RGB-D image from the camera 2. The measurement object O may be measured by the user.

In step S302, the processor 201 reads one ideal depth image from a shape DB 11. The processor 201 reads the ideal depth image in numerical order of a data set, for example. In step S302, the processor 201 may read an ideal color image instead of the ideal depth image.

In step S303, the processor 201 compares the read ideal depth image with a measurement depth image that is the depth image of the measurement object O to calculate similarity between them. In step S303, the processor 201 may compare the images by color.

In step S304, the processor 201 determines whether the similarity is high. If the calculated similarity is the highest, the processor 201 determines that the similarity is high. If the calculated similarity is equal to or greater than a threshold value, the processor 201 also determines that the similarity is high. If the processor determines in step S304 that the similarity is high, the process proceeds to step S305. If the processor does not determine in step S304 that the similarity is high, the process returns to step S302. In this case, the processor 201 reads another ideal depth image from the shape DB 11 and compares the images again.

In step S305, the processor 201 selects, as a data set corresponding to the measurement object O, a data set including the ideal depth image that is determined to have high similarity.

In step S306, the processor 201 reads an ideal color image of the selected data set from the shape DB 11.

In step S307, the processor 201 compares the color histogram of the read ideal color image with that of the measured color image that is a color image of the measurement object O to calculate similarity between the color histograms. The color histogram is the frequency distribution of RGB values of pixels of an image.

In step S308, the processor 201 specifies a color having no similarity between the ideal color image and the measured color image. For example, the processor 201 calculates a difference between two color histograms and specifies a color having a difference greater than or equal to a threshold value as a color having no similarity.

In step S309, the processor 201 filters a point cloud of a color having no similarity among measurement point clouds. That is, the processor 201 removes from the measurement point cloud the point cloud of a color that is not included in the alignment point cloud.

In step S310, the processor 201 reads the alignment point cloud of the selected data set from the shape DB 11.

In step S311, the processor 201 generates a measurement point cloud from the depth image obtained from the camera 2 and downsamples the measurement point cloud to the same density as that of the read alignment point cloud. The downsampling method may be performed by any technique, such as averaging adjacent point clouds.

In step S312, the processor 201 aligns the measurement point cloud and the alignment point cloud. Since, as described above, a point cloud of a color that is not included in the alignment point cloud is removed from the measurement point cloud, the alignment can be performed with accuracy. The alignment may be performed by any technique such as an ICP technique.

In step S313, the processor 201 reads a shape comparison point cloud of the selected data set from the shape DB 11.

In step S314, the processor 201 calculates a shape deviation between the measurement point cloud and the shape comparison point cloud.

In step S315, the processor 201 visualizes the shape deviation on the display device 3 based on the calculation. For example, the processor 201 superimposes a three-dimensional image, which is based upon the shape comparison point cloud, on a three-dimensional image which is based upon the measurement point cloud, and displays a shape deviation by, for example, changing the density of color to be displayed according to the size of the shape deviation in the superimposed images. After that, the process shown in FIG. 13 ends.

As described above, according to the third embodiment, a point cloud of a color having no similarity is removed from the measurement point cloud based on a result of comparison between an ideal color image and a measurement color image. The color having no similarity is considered to a color that is not included in an ideal measurement object. The point cloud of a color having no similarity can be an error factor in alignment. If, therefore, the point cloud is removed from the measurement point cloud, it is expected that the alignment of the point cloud may be performed with high accuracy.

FIG. 13 shows an example of application to the shape deviation visualization process of the first embodiment shown in FIG. 3. The third embodiment may also be applied to the modification of the first embodiment shown in FIG. 8.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measurement system including a processor with hardware configured to:
select a data set from a database, based on similarity obtained from a result of comparison between an ideal image and a measurement image, the ideal image being an image of an ideal measurement object having an ideal shape for a measurement object, the measurement image being an image of the measurement object obtained by measuring the measurement object, the database storing a data set for measurement objects each including the ideal image, an alignment point cloud, and a shape comparison point cloud, when viewed from a plurality of fields of view, the alignment point cloud for alignment with the measurement point cloud, and a shape comparison point cloud for comparison of shape with the measurement point cloud;
align the alignment point cloud included in the selected data set with the measurement point cloud;
calculate a shape deviation between the shape comparison point cloud and the measurement point cloud, which are included in the selected data set, based on a result of the alignment; and
visualize on a display device based on a result of the calculation of the shape deviation.

2. The measurement system of claim 1, wherein:
the alignment point cloud has density that is lower than density of the measurement point cloud; and
the shape comparison point cloud has density that is equal to density of the measurement point cloud.

3. The measurement system of claim 1, wherein the alignment point cloud is a point cloud in which a shape comparison portion, which is a portion where a shape deviation is generated between the shape comparison point cloud and the measurement point cloud, is removed from the shape comparison point cloud.

4. The measurement system of claim 1, wherein the ideal image includes one or both of a depth image and a color image.

5. The measurement system of claim 1, wherein:
the database further includes a similarity evaluation point cloud that is a point cloud for evaluation of similarity with the measurement point cloud corresponding to the ideal measurement object viewed from a plurality of fields of view;
the processor selects a plurality of first data sets of a predetermined field of view from the database based on a result of comparison between the measurement image and the ideal images;
the processor selects a second data set from the database based on a result of comparison between the similarity evaluation point cloud of each of the selected first data sets and the measurement point cloud;
the processor aligns the alignment point cloud included in the selected second data set with the measurement point cloud; and
the processor calculates a shape deviation between the shape comparison point cloud included in the data set selected and the measurement point cloud, based on a result of the alignment.

6. The measurement system of claim 1, wherein:
the database stores the data set for a measurement object for each work; and
the processor compares the measurement image and the ideal image included in the data set for set work.

7. The measurement system of claim 6, wherein the processor makes guide display for measurement of the measurement object on the display device, based on the ideal image included in the data set for the set work.

8. The measurement system of claim 1, wherein:
the processor specifies dissimilar color between the measurement image and the ideal image; and
the processor aligns a measurement point cloud in which a point cloud of the dissimilar color is excluded from the measurement point cloud with the alignment point cloud.

9. A non-transitory processor readable storage medium which stores a measurement program to cause a processor to:
select a data set from a database, based on similarity obtained from a result of comparison between an ideal image and a measurement image, the ideal image being an image of an ideal measurement object having an ideal shape for a measurement object, the measurement image being an image of the measurement object obtained by measuring the measurement object, the database storing a data set for measurement objects each including the ideal image, an alignment point cloud, and a shape comparison point cloud, when viewed from a plurality of fields of view, the alignment point cloud for alignment with the measurement point cloud, and a shape comparison point cloud for comparison of shape with the measurement point cloud;
align the alignment point cloud included in the selected data set with the measurement point cloud;
calculate a shape deviation between the shape comparison point cloud and the measurement point cloud, which are included in the selected data set, based on a result of the alignment; and
visualize on a display device based on a result of the calculation of the shape deviation.
